(19) United States
(12) Patent Application Publication
(10) Pub. No.: US 2002/0080418 A1
(43) Pub. Date: Jun. 27, 2002

(54) Facsimile apparatus

(76) Inventors: Naoki Cho, Fukuoka (JP); Hirofumi Kasedo, Saga (JP)

Correspondence Address: Lawrence E. Ashery, Ratner & Prestia, Suite 301, One Westlakes, P.O. Box 980, Valley Forge, PA, 19482-0980, US

(21) Appl. No.: 09/994,249

(22) Filed: Nov. 26, 2001

(30) Foreign Application Priority Data
Nov. 27, 2000 (JP) 2000-359000

(51) Int. Cl. H04N 1/00

(52) U.S. Cl. 358/440; 358/437

(57) ABSTRACT

Disclosed is a facsimile apparatus showing easily and visually an external event occurrence or an internal state change of the apparatus. In this facsimile apparatus, call-in detecting means detects a call-in. Number display signal detecting means detects a number display signal. Luminous display body color control means controls the display color of a luminous display body. Further, when the call-in detecting means detects a call-in and the telephone number indicated by the number display signal detected by the number display signal detecting means is matched with a telephone number registered in the facsimile apparatus, the luminous display body color control means illuminates the luminous display body by designating a predetermined color corresponding to the matched telephone number.

### FIELD OF THE INVENTION

The present invention relates to a facsimile apparatus incorporating a luminous display body or liquid crystal backlight.

### BACKGROUND OF THE INVENTION

Generally, the facsimile apparatus informs call-in by ringing a call-in tone or lighting a luminous display body. In the facsimile apparatus using a liquid crystal display device as the display, a backlight liquid crystal device is often used for displaying characters clearly. The following facsimile apparatus is disclosed in Japanese Laid-open Patent No. 2-23766.

In this facsimile apparatus, the luminous color of the display for displaying the state of operation is changed between the voice mail recording mode and other mode. Therefore, if the facsimile apparatus is installed in a remote place or dark place, its operation mode can be distinguished easily.

Japanese Laid-open Patent No. 3-1652 discloses the following facsimile apparatus.

In this facsimile apparatus, the luminous color of the display unit is changed in two or more colors. Therefore, without requiring extra display light, the user can distinguish the reception operation of the apparatus easily from a remote place or in a dark place.

Such a conventional facsimile apparatus having the luminous display body indicates the voice mail recording mode or the like by luminous color, or informs the call-in or receiving operation merely by emission of luminous display body.

### SUMMARY OF THE INVENTION

It is an object of the invention to present a facsimile apparatus capable of identifying the called-in partner easily. This facsimile apparatus changes the luminous state of the luminous body based on the state of the caller, information of caller's number or the like.

In an aspect of the facsimile apparatus of the invention, call-in detecting means detects a call-in. Number display signal detecting means detects a number display signal. Luminous display body color control means controls the color of the luminous display body.

Further, when the call-in detecting means detects a call-in, and the telephone number indicated by the number display signal detected by the number display signal detecting means and the telephone number registered in the facsimile apparatus are matched, the luminous display body color control means lights the luminous display body by designating a predetermined color corresponding to the matched telephone number.

Thus, the luminous display body color control means changes the luminous color of the luminous display body depending on the called-in partner.

In another aspect of the facsimile apparatus of the invention, a call-in detecting module detects a call-in. Color control means controls the color of a liquid crystal backlight.

Further, when the call-in detecting module detects a call-in, the color control means makes the liquid crystal backlight light up by designating a first predetermined color, and when a facsimile call-in is detected, the color control means makes the liquid crystal backlight light up by designating a second predetermined color.

Moreover, the color control means changes the color of the liquid crystal backlight based on an incoming event or an internal state change of the apparatus.

As a result, the user can identify the called-in partner without reading the detail of the display of liquid crystal provided in the facsimile apparatus, and can visually and easily recognize occurrence of an external event relating to the apparatus or an internal state change of the apparatus.

### BRIEF DESCRIPTION OF THE DRAWINGS

FIG. 1 is a block diagram of facsimile apparatus according to embodiment 1 of the invention.

FIG. 2 is a block diagram of facsimile apparatus according to embodiment 2 of the invention.

FIG. 3 is a block diagram of facsimile apparatus according to embodiment 3 of the invention.

FIG. 4 is a block diagram of facsimile apparatus according to embodiment 4 of the invention.

FIG. 5 is a block diagram of facsimile apparatus according to embodiment 5 of the invention.

FIG. 6 is a block diagram of facsimile apparatus according to embodiment 6 of the invention.

### DETAILED DESCRIPTION OF EXEMPLARY EMBODIMENTS

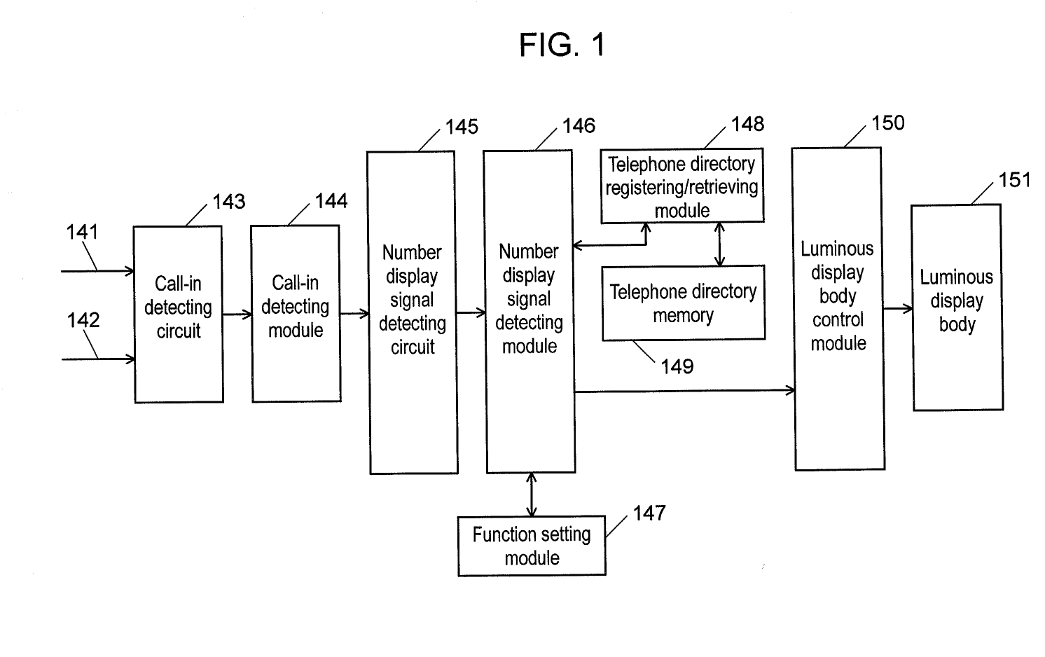

Exemplary embodiments of the invention are demonstrated hereinafter by referring to FIG. 1 to FIG. 6.

(Embodiment 1)

FIG. 1 is a block diagram of facsimile apparatus according to embodiment 1 of the invention.

In FIG. 1, the facsimile apparatus includes a call-in detecting circuit 143, a call-in detecting module 144, a number display signal detecting circuit 145, a number display signal detecting module 146, a function setting module 147, a telephone directory registering/retrieving module 148, a telephone directory memory 149, a luminous display body control module 150, and a luminous display body 151.

The call-in detecting module 144 detects a call-in signal 141 and a number display signal 142 from the telephone circuit. The module 146 functions also as color control circuit. In the telephone directory memory 149, telephone numbers registered in this facsimile apparatus are stored.

In the facsimile apparatus having such a configuration, the operation is as follows.

The call-in detecting circuit 143 detects a call-in signal 141, and transfers the input waveform of call-in signal to the call-in detecting module 144.

The call-in detecting module 144 analyzes the call-in signal waveform, and when a call-in is judged, the module 144 starts up the number display signal detecting circuit 145. At this time, the number display signal detecting circuit 145 starts detecting a number display signal.

When the number display signal detecting module 146 judges detection of the number display signal, the module 146 starts up the telephone directory registering/retrieving module 148.

The telephone directory registering/retrieving module 148 retrieves the telephone directory memory 149, and judges if the telephone number in the number display signal is matched with those stored in the memory 149 or not. If a matched telephone number is found, the number display signal detecting module 146 refers to what color is set as a display color of the matched telephone number, in the function setting module 147. On the basis of the result, the module 146 requests the luminous display body control module 150 to light up a prescribed color.

The luminous display body control module 150 acquires the information from the function setting module 147, and requests, on the basis of this information, the luminous display body 151 to light up the predetermined color.

Thus, according to the embodiment, the following operation is carried out.

The call-in detecting module 144 detects a call-in. The number display signal detecting module 146 detects a number display signal. The telephone directory registering/retrieving module 148 registers and retrieves the telephone directory.

Further, the telephone directory registering/retrieving module 148 judges the telephone number in the number display signal and the telephone number registered in the facsimile apparatus are matched. At this time, the color control circuit—herein included in the number display signal detecting module 146—makes the luminous display body 151 light up by designating a predetermined color corresponding to the matched telephone number.

As a result, the facsimile apparatus can display a call-in from a telephone number matched with a registered telephone number by lighting up a predetermined color of the luminous display body 151. In other words, the display color of the luminous display body is changed depending on the called-in partner.

Therefore, the user can easily identify the called-in partner.

(Embodiment 2)

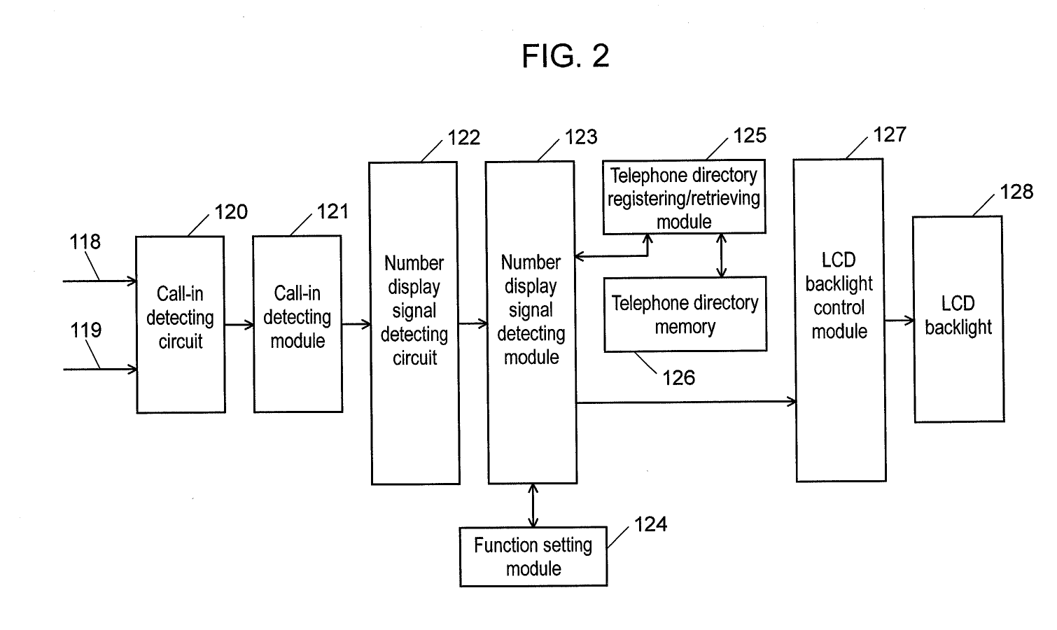

FIG. 2 is a block diagram of facsimile apparatus according to embodiment 2 of the invention.

The facsimile apparatus of this embodiment has a liquid crystal display unit.

In FIG. 2, the facsimile apparatus includes a call-in detecting circuit 120, a call-in detecting module 121, a number display signal detecting circuit 122, a number display signal detecting module 123, a function setting module 124, a telephone directory registering/retrieving module 125, a telephone directory memory 126, an LCD backlight control module 127, and an LCD backlight 128.

Herein, the LCD backlight 128 is a light for illuminating the liquid crystal display unit from the back side. The call-in detecting module 121, in the same way as in embodiment 1, recognizes a call-in signal 118 and a number display signal 119 from the telephone circuit. The number display signal detecting module 123 functions also as a color control circuit.

In the facsimile apparatus having such a configuration, the operation is as follows.

The operation of the call-in detecting circuit 120, call-in detecting module 121, number display signal detecting circuit 122, number display signal detecting module 123, function setting module 124, telephone directory registering/retrieving module 125, and telephone directory memory 126 is the same manner as the operation of the call-in detecting circuit 143, call-in detecting module 144, number display signal detecting circuit 145, number display signal detecting module 146, function setting module 147, telephone directory registering/retrieving module 148, and telephone directory memory 149 in embodiment 1, respectively.

If a telephone number matched with the telephone number in the number display signal is found in the telephone directory memory 126, the number display signal detecting module 123 refers to what color is set as a display color of backlight of the matched telephone number, in the function setting module 124. On the basis of the result, the module 123 requests the LCD backlight control module 127 to light up a predetermined backlight color.

The LCD backlight control module 127 acquires the information from the function setting module 124, and confirms, on the basis of this information, that the LCD backlight control is set in “automatic” mode. Then, the module 127 requests the LCD backlight 128 to illuminate the predetermined backlight color.

Thus, according to the embodiment, the following operation is carried out.

The call-in detecting module 121 detects a call-in. The number display signal detecting module 123 detects a number display signal. The telephone directory registering/retrieving module 125 registers and retrieves the telephone directory. Further, the telephone directory registering/retrieving module 125 judges the telephone number in the number display signal and the telephone number registered in the facsimile apparatus are matched. At this time, the color control circuit—herein included in the number display signal detecting module 123—lights up the LCD backlight 128 by designating a predetermined color corresponding to the matched telephone number.

Thus, the facsimile apparatus can display a call-in from a telephone number matched with a registered telephone number by lighting up a predetermined color of the LCD backlight 128.

(Embodiment 3)

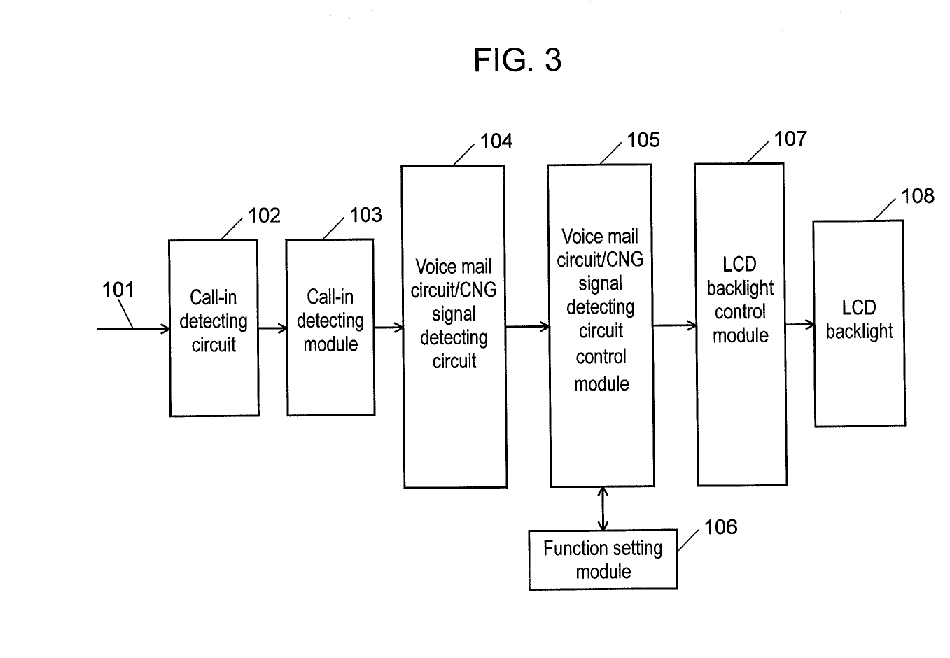

FIG. 3 is a block diagram of facsimile apparatus according to embodiment 3 of the invention.

In FIG. 3, the facsimile apparatus includes a call-in detecting circuit 102, a call-in detecting module 103, a voice mail circuit/calling tone (CNG) signal detecting circuit (hereafter called VCD circuit) 104, a voice mail circuit/CNG signal detecting circuit control module (hereinafter called VCDC control module) 105, a function setting module 106, an LCD backlight control module 107, and an LCD backlight 108.

Herein, the call-in detecting module 103 recognizes a call-in signal 101 from the telephone circuit. The VCD circuit 104 functions also as color control circuit.

In the facsimile apparatus having such a configuration, the operation is as follows.

The call-in detecting circuit 102 detects a call-in signal 101, and transfers the waveform of call-in signal to the call-in detecting module 103. The call-in detecting module 103 analyzes the call-in signal waveform, and when a call-in is judged, the VCD circuit 104 is started up. The voice mail circuit of the VCD circuit receives an instruction from the VCDC control module 105, and replies a voice mail message. At the same time, the voice mail circuit requests the LCD backlight control module 107 to light up an LCD backlight in a yellowish green color showing a start of voice mail by way of the VCDC control module 105.

The LCD backlight control module 107 acquires the information from the function setting module 106, and confirms, on the basis of this information, that the LCD backlight control is set not in “manual” but in “automatic” mode. Then, the module 107 requests the LCD backlight 108 to illuminate a yellowish green color.

While the voice mail reply message from the facsimile apparatus is flowing in the telephone circuit, the VCD circuit 104 is detecting a CNG signal incoming from the telephone circuit.

When the VCDC control module 105 judges that the CNG signal is detected, the function setting module 106 confirms that the LCD backlight control is set in “automatic” mode. Next, the function setting module 106 instructs the LCD backlight control module 107 to illuminate a blue backlight. The LCD backlight control module 107 requests the LCD backlight 108 to illuminate a blue backlight to show a start of facsimile communication.

The call-in detecting circuit 102, call-in detecting module 103, function setting module 106, LCD backlight control module 107, and LCD backlight 108 may be shared commonly with the call-in detecting circuit 120, call-in detecting module 121, function setting module 124, LCD backlight control module 127, and LCD backlight 128 in embodiment 2. When they are commonly shared, this embodiment may be combined with embodiment 2.

Thus, according to the embodiment, the following operation is carried out.

The call-in detecting module 103 detects a call-in. The call-in detecting module 103 detects a call-in in the voice mail mode. When the voice mail of the facsimile apparatus replies, the VCD circuit 104 including the color control circuit illuminates the LCD backlight 108 by designating a first predetermined color showing a start of operation of voice mail.

When the VCDC control module 105 detects a CNG signal, the color control circuit 104 illuminates the LCD backlight 108 by designating a second predetermined color different from the first predetermined color to show that the call-in is a facsimile reception.

Thus, the start of operation of voice mail, and the detection of CNG signal, that is, the start of facsimile communication can be displayed by the first and second predetermined colors of the LCD backlight 108.

(Embodiment 4)

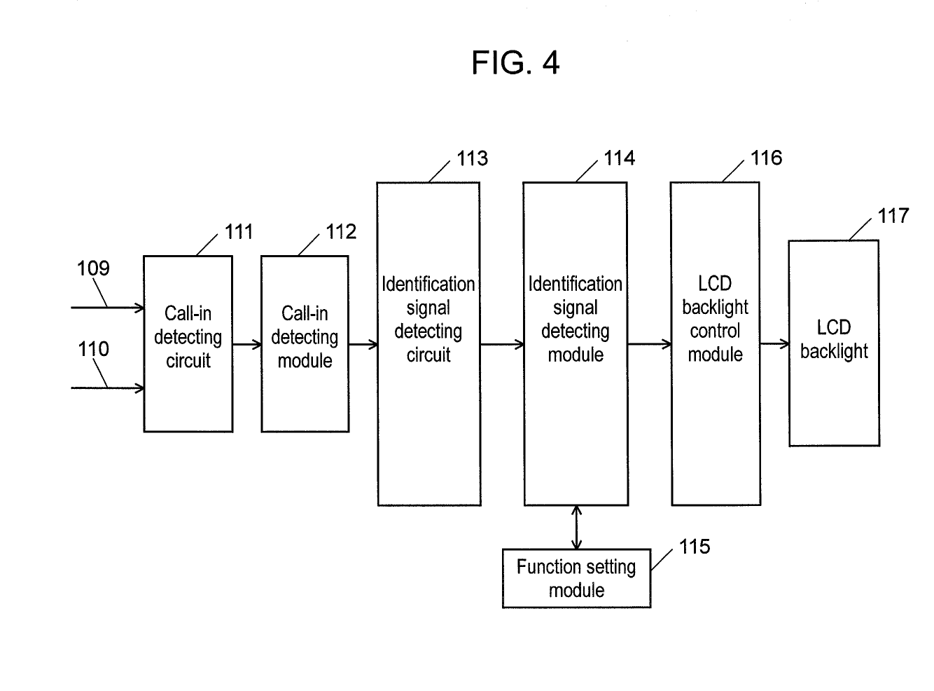

FIG. 4 is a block diagram of facsimile apparatus according to embodiment 4 of the invention.

In FIG. 4, the facsimile apparatus includes a call-in detecting circuit 111, a call-in detecting module 112, an identification signal detecting circuit 113, an identification signal detecting module 114, a function setting module 115, an LCD backlight control module 116, and an LCD backlight 117.

Herein, the call-in detecting circuit 111 detects a call-in signal 109 from the telephone circuit and an E-mail call-in identification signal 110 from an E-mail server. The call-in detecting module 112 recognizes a call-in signal 109.

The identification signal detecting circuit 113 detects an identification signal 110 from the E-mail server. The identification signal detecting module 114 recognizes an identification signal 110 from the E-mail server, and also functions as a color control circuit.

In the facsimile apparatus having such a configuration, the operation is as follows.

The call-in detecting circuit 111 informs the call-in detecting module 112 of input waveform of call-in signal 110. The call-in detecting module 112 analyzes the call-in signal waveform, and when a call-in is judged, the identification signal detecting circuit 113 is started up. The identification signal detecting circuit 113 starts detecting an identification signal 110 from the E-mail server. This identification signal is composed of four consecutive pieces of BC, BC, BC, BC of digital tone multiplex frequency (DTMF).

When the identification signal detecting module 114 detects this identification signal, the identification signal detecting module 114 requests the LCD backlight control module 116 to control to light up an orange backlight. Herein, the orange backlight shows a start of e-mail communication.

The LCD backlight control module 116 acquires the information from the function setting module 115, and confirms, on the basis of this information, that the LCD backlight control is set in “automatic” mode. Then, the module 116 requests the LCD backlight 117 to illuminate an orange color.

The call-in detecting circuit 111, call-in detecting module 112, function setting module 115, LCD backlight control module 116, and LCD backlight 117 may be shared commonly with the call-in detecting circuit 120, call-in detecting module 121, function setting module 124, LCD backlight control module 127, and LCD backlight 128 in embodiment 2. When they are commonly shared, this embodiment may be combined with embodiment 2.

Thus, according to the embodiment, the following operation is carried out.

The call-in detecting module 112 detects a call-in. The identification signal detecting module 114 detects an identification signal 109 from the E-mail server. The call-in detecting module 112 detects a call-in from the E-mail server. When the identification signal detecting module 114 detects an identification code showing the call-in of an E-mail, the color control circuit—herein included in the identification signal detecting module 114—illuminates the LCD backlight by designating a predetermined color showing the call-in of an E-mail.

Thus, the facsimile apparatus can display the call-in of an E-mail by lighting up a predetermined color of the LCD backlight.

Therefore, according to embodiments 2 to 4, the user can visually and easily recognize the occurrence of an external event relating to the apparatus without reading the detail of the display of liquid crystal provided in the apparatus.

(Embodiment 5)

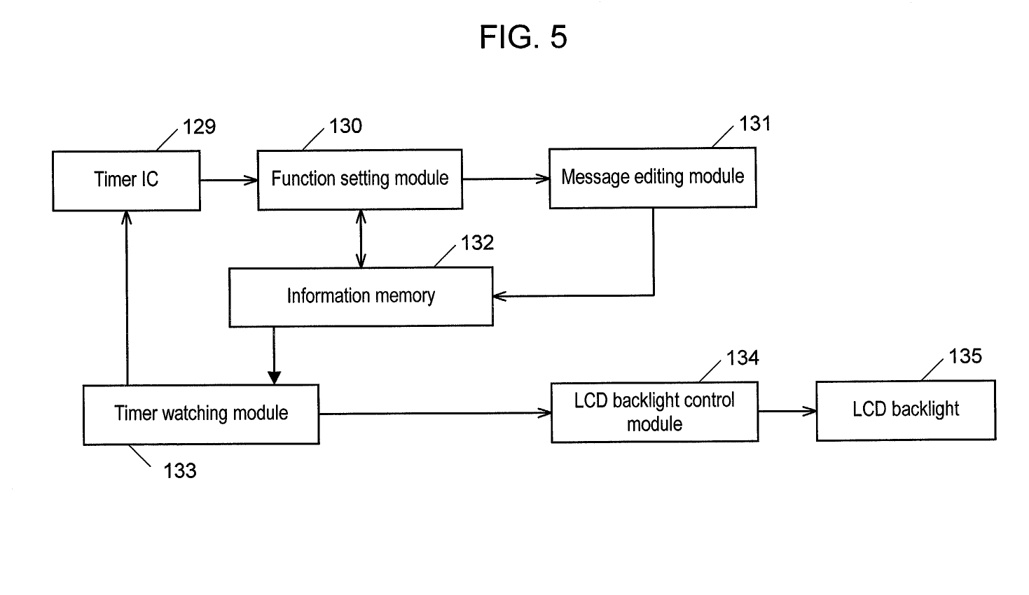

FIG. 5 is a block diagram of facsimile apparatus according to embodiment 5 of the invention.

In FIG. 5, the facsimile apparatus contains a timer IC 129, a function setting module 130, a message editing module 131, an information memory 132, a timer watching module 133, an LCD backlight control module 134, and an LCD backlight 135.

Herein, the timer IC 129 counts the time of the clock. The information memory 132 stores the time, date, message, and backlight information. The timer watching module 133 also functions as color control circuit.

In the facsimile apparatus having such a configuration, the operation is as follows.

The “message desired to be displayed” and “its display date” input by the user are stored in the information memory 132, by way of the message editing module 131 and function setting module 130.

The timer watching module 133 is always comparing the present date of the timer IC 129 and the “display date” (setting date) stored in the information memory 132. At a predetermined date, the timer watching module 133 fetches the message and backlight information from the information memory 132. Further, the module 133, functioning as color control unit, requests the LCD backlight control module 134 to display the message and illuminate the backlight in a predetermined color.

The LCD backlight control module 134 requests the LCD backlight 135 to display the message and illuminate the backlight in a predetermined color.

The function setting module 130, LCD backlight control module 134, and LCD backlight 135 may be shared commonly with the function setting module 124, LCD backlight control module 127, and LCD backlight 128 in embodiment 2. When they are commonly shared, this embodiment may be combined with embodiment 2.

Thus, the user can set the “message desired to be displayed” and “its display date”.

For example, the user can set to display “Happy birthday” on a yellow backlight automatically on the birthday of the child, so that the embodiment may be used as means of communication in the family.

Thus, according to the embodiment, the following operation is carried out.

The timer (timer IC) 129 outputs the present date and time. The timer watching module 133 as color control circuit judges if the present date reaches the preset date or not. When the module 133 judges that the timer 129 reaches the preset date and time, the module 133 designates a predetermined color, and makes the LCD backlight 135 light up. As a result, it is noticed that the present date has reached the preset date by lighting up the LCD backlight 135 in a predetermined color.

(Embodiment 6)

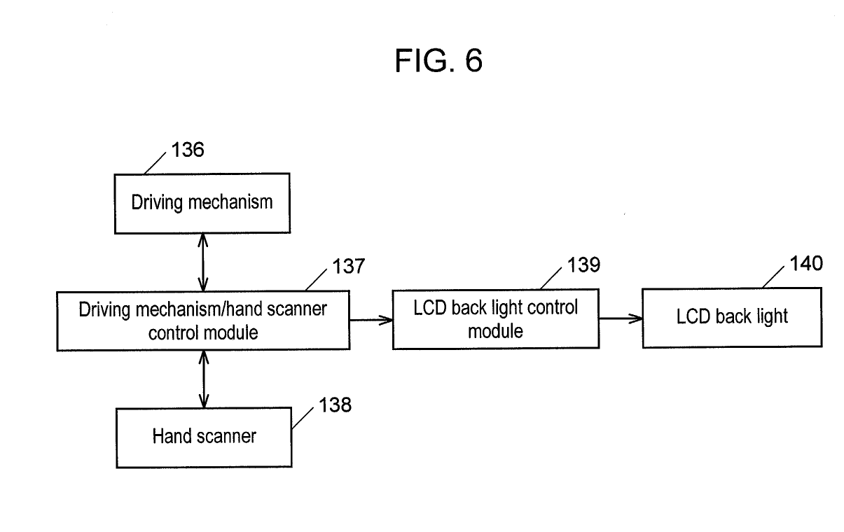

FIG. 6 is a block diagram of facsimile apparatus according to embodiment 6 of the invention.

In FIG. 6, the facsimile apparatus contains a driving mechanism 136, a driving mechanism/hand scanner control module (hereinafter called DH control module) 137, a hand scanner 138, an LCD backlight control module 139, and an LCD backlight 140.

Herein, the DH control module 137 functions as a color control circuit. The DH control module 137 controls the driving mechanism and hand scanner. The DH control module 137 and hand scanner 138 constitute an irregular condition detector.

The driving mechanism 136 makes mechanical actions such as driving of recording paper.

In the facsimile apparatus having a such configuration, the operation is as follows.

During copy operation of the driving mechanism 136, the DH control module 137 detects “no recording paper”, “no film”, “overheat”, or “paper jamming.”

During this time, the hand scanner 138 detects “abnormal mounting of hand scanner on facsimile apparatus main body (for example, imperfect contact of a hand scanner)”, “hand scanner battery consumed” or the like. The hand scanner 138 transfers the detected information to the DH control module 137.

The DH control module 137 transfers the error information detected by the DH control module 137 and hand scanner 138 to the LCD backlight control module 139. Further, the DH control module 137 requests the LCD backlight control module 139 to make the LCD backlight 140 light up in a red color to notify occurrence of irregular condition.

The LCD backlight control module 139 and LCD backlight 140 may be shared commonly with the LCD backlight control module 127 and LCD backlight 128 in embodiment 2. When they are commonly shared, this embodiment may be combined with embodiment 2.

Thus, according to the embodiment, the irregular condition detectors 137, 138 can detect an irregular condition such as no recording paper, no film, paper jamming, imperfect contact of hand scanner or battery consumption. When an irregular condition is detected by the irregular condition detectors 137, 138, the DH control module 137 functions as a color control unit and makes the LCD backlight 140 light up by designating a predetermined color. As a result, the facsimile apparatus informs occurrence of irregular condition by a predetermined color of the LCD backlight 140.

Therefore, according to embodiments 5 and 6, the user can visually and easily recognize an internal state change of the apparatus without reading the detail of the display of liquid crystal provided in the apparatus.

As explained herein, 1) the facsimile apparatus of the invention, when judging that the telephone number indicated by the number display signal is matched with a telephone number registered in the apparatus, illuminates the luminous display body by designating a predetermined color corresponding to the matched telephone number.

Therefore, the user can easily and visually identify the called-in partner.

2) The facsimile apparatus can also display a reply of voice mail by changing the color of LCD backlight.

In this facsimile apparatus, the color control circuit makes the LCD backlight light up by designating a first predetermined color indicating a start of operation of voice mail. When a CNG signal is detected, the color control circuit makes the LCD backlight light up by designating a second predetermined color indicating a facsimile call-in.

Thus, the facsimile apparatus can inform a start of operation of voice mail and detection of a CNG signal, that is, a start of facsimile communication, by first and second predetermined colors of the LCD backlight.

3) The facsimile apparatus also informs a call-in of E-mail by a predetermined color of the LCD backlight.

4) Further, the facsimile apparatus, when judging that the telephone number indicated by the number display signal is matched with a telephone number registered in the apparatus, lights up the LCD backlight by designating a predetermined color corresponding to the matched telephone number.

Accordingly, the call-in of E-mail from the telephone number matched with the registered telephone number can be displayed by a predetermined color of the LCD backlight.

5) The facsimile apparatus also includes a timer for setting the date and time, and the color control circuit judges if the present date has reached the preset date, and when judged to have reached, the LCD backlight is illuminated by designating a predetermined color.

Thus, the facsimile apparatus informs that the present date has reached the preset data by lighting up a predetermined color of the LCD backlight.

Therefore, in examples of 2) to 5), the user can visually and easily recognize an internal state change of the apparatus without reading the detail of the display of liquid crystal provided in the facsimile apparatus.

6) Moreover, the facsimile apparatus contains an irregular condition detector for detecting an irregular condition such as no recording paper, no film, paper jamming, imperfect contact of hand scanner, or battery consumption. When an irregular condition is detected by an irregular condition detector, the color control circuit lights up the LCD backlight by designating a predetermined color. Thus, the facsimile apparatus can inform occurrence of irregular condition by a predetermined color of the LCD backlight.

Therefore, in this embodiment, too, the user can visually and easily recognize an internal state change of the apparatus without reading the detail of the display of liquid crystal provided in the apparatus.

What is claimed is:

1. A facsimile apparatus comprising:
(a) call-in detecting means for detecting a call-in,
(b) number display signal detecting means for detecting a number display signal, and
(c) luminous display body color control means for controlling the display color of a luminous display body,
wherein when the call-in detecting means detects the call-in and a telephone number indicated by the number display signal detected by the number display signal detecting means is matched with a telephone number registered in the facsimile apparatus, the luminous display body color control means makes the luminous display body illuminate by designating a predetermined color corresponding to the matched telephone number.

2. The facsimile apparatus of claim 1, further comprising:
(d) a telephone directory registering/retrieving module for retrieving information including a telephone number registered in a telephone directory memory,
wherein said call-in detecting means is a call-in detecting module, said number display signal detecting means is a number display signal detecting module, said luminous display body color control means is a luminous display body color control unit, and when the telephone directory registering/retrieving module judges that the telephone number indicated by the number display signal is matched with a telephone number registered in the facsimile apparatus, the luminous display body color control unit makes the luminous display body illuminate by specifying a predetermined color corresponding to the matched telephone number.

3. A facsimile apparatus comprising:
(a) a call-in detecting module for detecting a call-in, and
(b) a color control unit for controlling the color of an LCD backlight,
wherein i) when the call-in detecting module detects the call-in, the color control unit makes the LCD backlight light up by designating a first predetermined color, and ii) when a facsimile call-in is detected, the color control unit makes the LCD backlight light up by designating a second predetermined color.

4. The facsimile apparatus of claim 3, wherein when the call-in detecting module detects a call-in in a voice mail mode and a voice mail is started, the color control unit makes the LCD backlight light up by designating a third predetermined color showing the start of the voice mail.

5. The facsimile apparatus of claim 3, wherein when a CNG signal is detected, the LCD backlight is illuminated by designating the second predetermined color showing the facsimile call-in.

6. The facsimile apparatus of claim 3, wherein when the call-in is a call-in in a voice mail mode and a voice mail is started, the first predetermined color shows a start of operation of the voice mail, and when a CNG signal is detected, the facsimile call-in is detected, and the second predetermined color indicates the facsimile call-in.

7. The facsimile apparatus of claim 3, further comprising:
(c) an identification signal detecting module for detecting an identification signal from an E-mail server,
wherein when the call-in detecting module detects the call-in and the identification signal detecting modules detects an identification code showing a call-in of E-mail, the color control unit makes the LCD backlight light up by designating a third predetermined color showing the call-in of the E-mail.

8. The facsimile apparatus of claim 7, further comprising:
(d) a number display signal detecting module for detecting a number display signal, and
(e) a telephone directory registering/retrieving module for registering and retrieving a telephone directory,
wherein when the number display signal detecting module detects the number display signal, and the telephone directory registering/retrieving module judges that the telephone number indicated by the number display signal is matched with a telephone number registered in the telephone directory, the color control circuit makes the LCD backlight light up by designating a fourth predetermined color corresponding to the matched telephone number.

9. The facsimile apparatus of claim 3, further comprising:
(c) a timer showing the present date and time,
wherein the color control unit judges if the present date has reached a preset date, and when the present date is judged to coincide with the preset date, the LCD backlight is illuminated by designating a third predetermined color.

10. The facsimile apparatus of claim 3, further comprising:
(c) an irregular condition detector for detecting an irregular condition of the facsimile apparatus,
wherein when the irregular condition detector detects the irregular condition, the color control circuit makes the LCD backlight light up by designating a predetermined color.

11. The facsimile apparatus of claim 3, further comprising:
(c) a number display signal detecting module for detecting a number display signal, and
(d) a telephone directory registering/retrieving module for registering and retrieving a telephone directory,
wherein when the number display signal detecting module detects the number display signal, and the telephone directory registering/retrieving module judges that the telephone number indicated by the number display signal is matched with a telephone number registered in the telephone directory, the color control circuit makes the LCD backlight light up by designating a third predetermined color corresponding to the matched telephone number.
